(19) United States
(12) Patent Application Publication
(10) Pub. No.: US 2026/0158445 A1
(43) Pub. Date: Jun. 11, 2026

(54) DOUBLE-LAYER THREE-WAY CATALYST

(71) Applicant: UMICORE AG & CO. KG, Hanau-Wolfgang (DE)

(72) Inventors: Martin ROESCH, Rodgau (DE); Uta ALBOLD, Bad Orb (DE); Sonja BUCHBERGER, Frankfurt (DE); Joerg-Michael RICHTER, Frankfurt (DE)

(73) Assignee: UMICORE AG & CO. KG, Hanau-Wolfgang (DE)

(21) Appl. No.: 19/183,423

(22) Filed: Apr. 18, 2025

(30) Foreign Application Priority Data
Apr. 26, 2024 (DE) 102024111819.9

(51) Int. Cl. B01D 53/94; B01J 23/63; B01J 35/00; B01J 35/57; B01J 37/02; B01J 37/08; F01N 3/022; F01N 3/10; F01N 3/28

(52) U.S. Cl. CPC B01D 53/945; B01J 23/63; B01J 35/19; B01J 35/57; B01J 37/0244; B01J 37/08; F01N 3/0222; F01N 3/101; F01N 3/2828; B01D 2255/1021; B01D 2255/1023; B01D 2255/1025; B01D 2255/2061; B01D 2255/2063; B01D 2255/2065; B01D 2255/20715; B01D 2255/2092; B01D 2255/9022; B01D 2255/9155; B01D 2257/404; B01D 2257/502; B01D 2257/702; B01D 2258/014; F01N 2370/02; F01N 2510/0684

(57) ABSTRACT

The present invention relates to a catalyst comprising two layers arranged one above the other on an inert catalyst support, wherein a layer A contains at least palladium as a platinum group metal, aluminum oxide and a first cerium/zirconium/lanthanum/yttrium mixed oxide, and a layer B applied to layer A contains at least rhodium as a platinum group metal, aluminum oxide and a second cerium/zirconium/lanthanum/yttrium mixed oxide. In both layers A and B, the lanthanum oxide content is between 1 wt. % and 5 wt. %, based on the cerium/zirconium/lanthanum/yttrium mixed oxide, and the yttrium oxide content is between 8 wt. % and 20 wt. %, based on the cerium/zirconium/lanthanum/yttrium mixed oxide. Layer A of the catalyst according to the invention has a lower mass ratio of aluminum oxide to mixed oxide than layer B.

The present invention relates to a three-way catalyst which is composed of two catalytically active layers arranged one above the other and which is suitable for purifying exhaust gases from combustion engines, in particular predominantly stoichiometrically operated combustion engines.

Three-way catalysts are used for purifying exhaust gases from substantially stoichiometrically operated combustion engines. In stoichiometric operation, the quantity of air fed to the engine corresponds exactly to the quantity required for complete combustion of the fuel. In this case, the air-fuel ratio λ, also known as the air-fuel equivalence ratio, is exactly 1. Three-way catalysts at around λ=1 are able to simultaneously convert hydrocarbons, carbon monoxide, and nitrogen oxides to harmless components.

In general, platinum group metals are used as catalytically-active materials, particularly platinum, palladium and rhodium, which are, for example, present on γ aluminum oxide as support material. In addition, three-way catalysts contain oxygen storage materials, e.g., cerium/zirconium mixed oxides. In the latter case, cerium oxide, a rare earth metal oxide, constitutes the component that is fundamental to the oxygen storage. Along with zirconium oxide and cerium oxide, these materials may contain additional components, such as further rare earth metal oxides or alkaline earth metal oxides. Oxygen storage materials are activated by applying catalytically-active materials, such as platinum group metals, and therefore also serve as support material for the platinum group metals.

The components of a three-way catalyst may be present in a single coating layer on an inert catalyst support; see, for example, EP1541220B1.

However, double-layer catalysts are frequently used, which facilitate a separation of different catalytic processes and, therefore, enable an optimal coordination of the catalytic effects in the two layers. Catalysts of the latter type are disclosed, for example, in WO95/35152A1, WO2008/000449A2, EP0885650A2, EP1046423A2, EP1726359A1, and EP1974809B1.

EP1974809B1 discloses double-layer, three-way catalysts that contain cerium/zirconium mixed oxides in both layers, wherein the cerium/zirconium mixed oxide in the top layer respectively has a higher proportion of zirconium than that in the bottom layer.

EP1900416B1 describes double-layer, three-way catalysts that contain mixed oxides of cerium, zirconium, and neodymium in both layers and, additionally, cerium/zirconium/yttrium/lanthanum oxide-aluminum oxide particles in the bottom layer.

EP1726359A1 describes double-layer, three-way catalysts that contain cerium/zirconium/lanthanum/neodymium mixed oxides with a zirconium content of more than 80 mol % in both layers, wherein the cerium/zirconium/lanthanum/neodymium mixed oxide in the top layer may respectively have a higher proportion of zirconium than that in the bottom layer.

WO2008/000449A2 also discloses double-layer catalysts that contain cerium/zirconium mixed oxides in both layers, and wherein the mixed oxide in the top layer again has a higher proportion of zirconium. To some extent, the cerium/zirconium mixed oxides may also be replaced by cerium/zirconium/lanthanum/neodymium mixed oxides or cerium/zirconium/lanthanum/yttrium mixed oxides.

WO2009/012348A1 even describes three-layer catalysts wherein only the middle and the top layers contain oxygen storage materials.

EP3045226A1 discloses double-layer three-way catalysts with improved aging stability, wherein a layer A lying directly on the catalyst support contains at least one platinum group metal, as well as one cerium/zirconium/RE metal mixed oxide, and a layer B, applied on layer A and in direct contact with the exhaust gas stream, contains at least one platinum group metal, as well as a cerium/zirconium/RE mixed oxide, wherein RE stands for a rare-earth metal except for cerium. The proportion of RE oxide in the cerium/zirconium/RE mixed oxide of layer A in this case is smaller than the proportion of RE oxide in the cerium/zirconium/RE mixed oxide of layer B.

EP4096811A1 describes a catalyst that, due to its further increased temperature stability, has even lower light-off temperatures and an improved dynamic conversion capacity after aging, compared to the catalysts of the prior art. Said catalyst comprises two layers on an inert catalyst support, wherein a layer A contains at least palladium as a platinum group metal, as well as a cerium/zirconium/lanthanum/yttrium mixed oxide, and a layer B applied to layer A contains at least rhodium as a platinum group metal, as well as a cerium/zirconium/lanthanum/yttrium mixed oxide. In both layers A and B, the lanthanum oxide content is between 1 wt. % and 5 wt. %, based on the cerium/zirconium/lanthanum/yttrium mixed oxide, and the yttrium oxide content is between 8 wt. % and 20 wt. %, based on the cerium/zirconium/lanthanum/yttrium mixed oxide.

The constantly increasing demand for a reduction in emissions from combustion engines requires the continuous further development of catalysts. In order to limit and reduce greenhouse gas emissions from transport, many countries have introduced laws and regulations setting limits for CO₂ emissions from motor vehicles. For example, European Regulations (EC) No. 443/2009 and subsequently No. 631/2019 set annual average specific emissions of CO₂ for new passenger cars registered in the European Union. Accordingly, there are also government regulations on CO₂ emissions in the USA and China.

A technical possibility for reducing the CO₂ emissions of motor vehicles is to use hybrid drives, which can lower fuel consumption by means of partial electrification. Depending on the mode of operation, when using hybrid drives a transition from an electric driving state to driving with the combustion engine occurs while the vehicle is being driven. In such cases, the catalyst has to reach its operating temperature as quickly as possible in order to avoid excessive emissions of pollutants such as hydrocarbons, carbon monoxide and nitrogen oxides. The ability of a catalyst to reach its operating temperature as quickly as possible is also referred to as light-off performance. It is usually described by specifying the light-off temperature required for a certain percentage conversion of a pollutant component. For example, T₅₀ indicates the temperature at which 50% of the pollutant in question is converted. Accordingly, T₇₀ indicates that 70% conversion is achieved.

The catalysts according to the aforementioned prior art already have very good properties with regard to light-off performance. However, the technical developments mentioned regarding hybridization make it necessary to seek even better catalysts.

It was therefore the object of this invention to provide a catalyst which has significantly improved light-off performance for the conversion of hydrocarbons, carbon monoxide and nitrogen oxides.

It has now surprisingly been found that this object can be achieved by proposing a catalyst for reducing the harmful components in the exhaust gas of a combustion engine, in particular a predominantly stoichiometrically operated combustion engine, which comprises two layers arranged one above the other on an inert catalyst support, wherein a layer A contains at least palladium as a platinum group metal, aluminum oxide and a first cerium/zirconium/lanthanum/yttrium mixed oxide, and a layer B applied to layer A contains at least rhodium as a platinum group metal, aluminum oxide and a second cerium/zirconium/lanthanum/yttrium mixed oxide; in both layers A and B, the lanthanum oxide content is between 1 wt. % and 5 wt. %, based on the cerium/zirconium/lanthanum/yttrium mixed oxide, and the yttrium oxide content is between 8 wt. % and 20 wt. %, based on the cerium/zirconium/lanthanum/yttrium mixed oxide, wherein layer A has a mass ratio of aluminum oxide to mixed oxide of at least 2.5:1 and at most 3.5:1. By adjusting the composition of the mixed oxide and the quantitative ratio of the components, in particular in the lower layer, it was possible to further improve the light-off performance of the catalyst according to the invention. As shown in the examples, this makes it possible to achieve very good light-off performance both when the engine is fresh and after intensive aging, which ultimately leads to fewer emissions when driving, in particular in hybrid vehicles. Against the background of the cited prior art, this was not to be expected at all.

The bottom layer (layer A) of the catalyst according to the invention therefore has a mass ratio of aluminum oxide to mixed oxide of at least 2.5:1 and at most 3.5:1, preferably between 2.8:1 and 3.2:1. The top layer B preferably has a mass ratio of aluminum oxide to mixed oxide of at least 0.5:1 and at most 1.5:1, very preferably 0.8:1 to 1.5:1 and extremely preferably 1:1 to 1.5:1. A preferred embodiment is characterized in that the yttrium oxide content in both layers A and B is between 10 wt. % and 15 wt. %, based on the cerium/zirconium/lanthanum/yttrium mixed oxide. An yttrium oxide content between 12 wt. % and 13 wt. % is particularly preferred.

According to the invention, layer A contains at least palladium as a platinum group metal and layer B contains at least rhodium as a platinum group metal. In embodiments of the present invention, layer A and/or layer B, independently of one another, additionally contain platinum as a further platinum group metal. Layer A preferably contains palladium and platinum and layer B preferably contains rhodium and platinum or rhodium and palladium and platinum. In further embodiments of the present invention, the catalyst according to the invention is free of platinum. Particularly preferably, layer A contains only palladium and layer B only rhodium or layer B contains only palladium and rhodium.

Cerium/zirconium/lanthanum/yttrium mixed oxides may serve as support materials for the platinum group metals in layer A and/or in layer B. Furthermore, however, the platinum group metals in layer A and/or in layer B can also be supported wholly or in part on active aluminum oxide.

Therefore, in a preferred embodiment of the present invention, layer A and layer B contain active aluminum oxide. It is particularly preferable for the active aluminum oxide to be stabilized by means of doping, in particular with lanthanum oxide. Preferred active aluminum oxides contain 0.5 to 6 wt. %, in particular 3 to 5 wt. %, lanthanum oxide (La₂O₃).

The term “active aluminum oxide” is known to a person skilled in the art. It particularly describes γ aluminum oxide with a specific surface area of 100 m²/g to 200 m²/g. Active aluminum oxide is frequently described in the literature and is commercially available.

The term “cerium/zirconium/lanthanum/yttrium mixed oxide” within the meaning of the present invention excludes physical mixtures of cerium oxide, zirconium oxide, lanthanum oxide and yttrium oxide. Rather, “cerium/zirconium/lanthanum/yttrium mixed oxides” are characterized by a largely homogeneous, three-dimensional crystal structure that is ideally free of phases of pure cerium oxide, zirconium oxide or lanthanum oxide and yttrium oxide. Depending on the manufacturing process, however, not completely homogeneous products may arise which can generally be used without any disadvantage.

The cerium/zirconium/lanthanum/yttrium mixed oxides of the present invention do not, in particular, contain aluminum oxide in their crystal structure.

In embodiments of the present invention, one layer or both layers contain alkaline earth metal compounds, such as barium oxide or barium sulfate. Preferred embodiments contain barium sulfate in layer A. The quantity of barium sulfate amounts, in particular, to 5 g/l to 20 g/l of the volume of the inert catalyst support.

In further embodiments of the present invention, one or both layers additionally contain additives, such as rare-earth compounds, such as lanthanum oxide, and/or binders, such as aluminum compounds. These additives are used in quantities that may vary within wide limits and that a person skilled in the art can determine by simple means in the specific case.

In a further embodiment of the present invention, layer A lies directly on the inert catalyst support, i.e., there is no additional layer or no undercoat between the inert catalyst support and layer A. In a further embodiment of the present invention, layer B is in direct contact with the exhaust gas stream, i.e., there is no additional layer or no overcoat on layer B.

In a further embodiment of the present invention, the catalyst according to the invention consists of layers A and B on an inert catalyst support. This means that layer A lies directly on the inert catalyst support, layer B is in direct contact with the exhaust gas stream, and no other layers are present.

Honeycomb bodies made from ceramic or metal with a volume V, which have parallel flow channels for the exhaust gases of the combustion engine, are particularly suitable as catalytically-inert catalyst supports. They may be either so-called flow-through honeycomb bodies or wall flow filters. In particular in the case of a wall flow filter, the catalytic coating according to the invention can be located completely on, partially in or completely in the wall of the wall flow filter.

According to the invention, the wall areas of the flow channels are coated with the two catalyst layers A and B. In order to coat the catalyst support with layer A, the solids provided for this layer are suspended in water and the catalyst support is coated optionally on and/or in the wall with the coating suspension that is thus obtained. The layer is then advantageously dried and, if necessary, calcined. The process is repeated with a coating suspension, in which the solids that are provided for layer B are suspended in water. Finally, drying and calcination can again take place.

Preferably, both layer A and layer B are coated along the entire length of the inert catalyst support. This means that layer B completely covers layer A, and, as a result, only layer B comes into direct contact with the exhaust gas stream. However, a zoned coating variant is also possible in which, however, layer A is at least partially covered by layer B.

The present invention also relates to an exhaust system for reducing the harmful components in the exhaust gas of a combustion engine, in particular a predominantly stoichiometrically operated combustion engine, having a catalyst according to the invention. In addition, the exhaust system can contain other exhaust gas purification components known to a person skilled in the art for this purpose. Preferably, the exhaust system further comprises a particle filter. Advantageous exhaust systems in which one of the three-way catalysts can be replaced by the one according to the invention are described, for example, in WO2020079131A1.

The present invention also relates to the use of a catalyst according to the invention or the exhaust system according to the invention for reducing the harmful components in the exhaust gas of a combustion engine, in particular a predominantly stoichiometrically operated combustion engine. However, a preferred use is one in which the combustion engine is located in a partially electrically powered hybrid vehicle. This type of vehicle has the ability to travel certain distances purely electrically. In such cases the combustion engine is switched off. The engine then no longer produces warming exhaust gases and the three-way catalyst located in the exhaust train cools down. There is a risk that the temperature of the catalyst will be too low when the combustion engine is switched back on. The result is that the exhaust gases can enter the atmosphere unabated. It is therefore particularly advantageous, in such situations, for the three-way catalyst to recover its so-called light-off temperature as quickly as possible. The three-way catalyst according to the invention can achieve this to a particularly impressive extent without otherwise reducing the exhaust gas purification performance. Against the background of the prior art, this was surprising.

### EXAMPLES

In the following example 1 and in comparative examples 1 and 2, double-layer catalysts were produced by twice coating flow-through honeycomb bodies made from ceramic with 93 cells per cm² and with a wall thickness of 0.11 mm, and dimensions of 11.8 cm in diameter and 11.4 cm in length. To this end, two different suspensions were produced, respectively for layer A and B. The support was first coated with the suspension for layer A and then calcined in air for 4 hours at 550° C. Subsequently, the support coated with layer A was coated with the suspension for layer B and then calcined under the same conditions as for layer A.

According to the invention, example 1 contains a higher proportion of aluminum oxide than comparative examples 1 and 2. The mass ratio of aluminum oxide to mixed oxide in example 1 is 3:1, while the comparative examples each have a ratio of mixed oxide to aluminum oxide of 1:1.

### Example 1

A double-layer catalyst was produced by first producing two suspensions.

The composition of the first suspension for layer A (based on the volume of the catalyst support) was 99.9 g/L with 4 wt. % of La₂O₃ stabilized activated aluminum oxide, 33.3 g/L of cerium/zirconium/lanthanum/yttrium mixed oxide with 24 wt. % of CeO₂, 60 wt. % of ZrO₂, 3.5 wt. % of La₂O₃ and 12.5 wt. % of Y₂O₃, 10 g/L BaSO₄, 3.178 g/L Pd.

The composition of the second suspension for layer B (based on the volume of the catalyst support) was 60 g/L with 4 wt. % of La₂O₃ stabilized activated aluminum oxide, 47 g/L of cerium/zirconium/lanthanum/yttrium mixed oxide with 24 wt. % of CeO₂, 60 wt. % of ZrO₂, 3.5 wt. % of La₂O₃ and 12.5 wt. % of Y₂O₃, 0.353 g/L Rh.

### Comparative Example 1 (According to EP4096811A1)

A double-layer catalyst was produced analogously to example 1. The composition of the first suspension for layer A (based on the volume of the catalyst support) was 66.6 g/L with 4 wt. % of La₂O₃ stabilized activated aluminum oxide, 66.6 g/L of cerium/zirconium/lanthanum/yttrium mixed oxide with 24 wt. % of CeO₂, 60 wt. % of ZrO₂, 3.5 wt. % of La₂O₃ and 12.5 wt. % of Y₂O₃, 10 g/L BaSO₄, 3.178 g/L Pd.

The composition of the second suspension for layer B was the same as in example 1.

### Comparative Example 2 (According to EP1974809B1)

A double-layer catalyst was produced analogously to example 1. The composition of the first suspension for layer A (based on the volume of the catalyst support) was 66.6 g/L with 4 wt. % of La₂O₃ stabilized activated aluminum oxide, 66.6 g/L of cerium/zirconium/lanthanum/yttrium mixed oxide with 44.5 wt. % of CeO₂, 44.5 wt. % of ZrO₂, 6 wt. % of La₂O₃ and 5 wt. % of Y₂O₃, 10 g/L BaSO₄, 3.178 g/L Pd.

The composition of the second suspension for layer B was the same as in example 1.

For example 1 and the comparative examples 1 and 2, the light-off performance was freshly tested on an engine test bench at a constant average air-fuel equivalence ratio of 2.

Table 1 contains the temperatures T₅₀ at which in each case 50% of the component in question are converted. Here, the light-off performance with a stoichiometric exhaust gas composition (λ=0.999 with ±3.4% amplitude) was determined. Example 1 exhibits lower light-off temperatures for all pollutants than the comparative examples.

TABLE 1
Light-off performance fresh

| | T₅₀ HC | T₅₀ CO | T₅₀ NOx |
|---|---|---|---|
| | stoichiometric | stoichiometric | stoichiometric |
| Example 1< | 218° C. | 211° C. | 212° C. |
| Comparative | 226° C. | 222° C. | 224° C. |
| example 1 | | | |
| Comparative | 226° C. | 222° C. | 223° C. |
| example 2 | | | |

Example 1 and comparative examples 1 and 2 were aged in an engine test bench aging process. The aging process consisted of an overrun cut-off aging process with an exhaust gas temperature of 950° C. before the catalyst input. This resulted in a maximum bed temperature of 1020° C. in the catalyst. The aging time was 115 hours.

Subsequently, the light-off performance was tested after aging on an engine test bench at a constant average air-fuel equivalence ratio of λ.

Table 2 contains the temperatures T₅₀ at which in each case 50% of the component in question is converted. Here, the light-off performance with a stoichiometric exhaust gas composition (λ=0.999 with ±3.4% amplitude) was determined. Example 1 exhibits lower light-off temperatures for all pollutants than the comparative examples.

TABLE 2
light-off performance after aging

| | T₅₀ HC | T₅₀ CO | T₅₀ NOx |
|---|---|---|---|
| | stoichiometric | stoichiometric | stoichiometric |
| Example 1 | 323° C. | 331° C. | 325° C. |
| Comparative | 333° C. | 341° C. | 338° C. |
| example 1 | | | |
| Comparative | 342° C. | 350° C. | 349° C. |
| example 2 | | | |

Subsequently, the dynamic conversion of carbon monoxide (CO), nitrogen oxides (NOx) and hydrocarbons (HC) was determined in a range for λ of 0.99 to 1.01 at a constant temperature of 510° C. The amplitude of λ was ±6.8%; the exhaust gas mass flow was 190 kg/h.

TABLE 3
Dynamic conversion

| | CO/NOx conversion | HC conversion at λ |
|---|---|---|
| | at the point of | of the CO/NOx point |
| | intersection | of intersection |
| Example 1 | 87.5% | 93% |
| Comparative example 1 | 88.5% | 93.5% |
| Comparative example 2 | 85.5% | 93 |

Table 3 contains the conversion at the point of intersection of the CO and NOx conversion curves, as well as the associated HC conversion. Example 1 exhibits almost the same dynamic CO/NOx conversion as comparative example 1 and better CO/NOx conversion than comparative example 2.

Overall, example 1 according to the invention exhibits a significant improvement in the light-off performance fresh and after aging for carbon monoxide, nitrogen oxides and hydrocarbons as well as almost the same or even better dynamic CO/NOx conversion and HC conversion after aging compared with the comparative examples.

1. A catalyst for reducing the harmful components in the exhaust gas of a combustion engine, in particular a predominantly stoichiometrically operated combustion engine, which comprises two layers arranged one above the other on an inert catalyst support, wherein
a layer A contains at least palladium as a platinum group metal, aluminum oxide and a first cerium/zirconium/lanthanum/yttrium mixed oxide and
a layer B applied to layer A contains at least rhodium as a platinum group metal, aluminum oxide and a second cerium/zirconium/lanthanum/yttrium mixed oxide,
in both layers A and B, the lanthanum oxide content is between 1 wt. % and 5 wt. %, based on the cerium/zirconium/lanthanum/yttrium mixed oxide, and the yttrium oxide content is between 8 wt. % and 20 wt. %, based on the cerium/zirconium/lanthanum/yttrium mixed oxide,
characterized in that
layer A has a mass ratio of aluminum oxide to mixed oxide of at least 2.5:1 and at most 3.5:1.

2. The catalyst according to claim 1, characterized in that layer B has a mass ratio of aluminum oxide to mixed oxide of at least 0.5:1 and at most 1.5:1.

3. The catalyst according to claim 1, characterized in that layer A and/or layer B, independently of one another, additionally contain platinum as a further platinum group metal.

4. The catalyst according to claim 1, characterized in that layer A contains only palladium and layer B only rhodium or layer B only palladium and rhodium as a platinum group metal.

5. The catalyst according to claim 1, characterized in that layer A and layer B contain active aluminum oxide.

6. The catalyst according to claim 1, characterized in that the platinum group metal in layer A and/or in layer B is supported fully or in part on active aluminum oxide.

7. The catalyst according to claim 1, characterized in that layer A lies directly on the inert catalyst support.

8. An exhaust system for reducing the harmful components in the exhaust gas of a combustion engine, in particular a predominantly stoichiometrically operated combustion engine, having a catalyst according to claim 1.

9. The exhaust system according to claim 8, characterized in that it further comprises a particle filter.

10. A use of a catalyst according to claim 1 for reducing the harmful components in the exhaust gas of a combustion engine, in particular a predominantly stoichiometrically operated combustion engine.

11. The use according to claim 10, characterized in that it is a combustion engine in a partially electrically powered hybrid vehicle.
